(19) United States
(12) Patent Application Publication
(10) Pub. No.: US 2009/0174893 A1
(43) Pub. Date: Jul. 9, 2009

(54) PRINT MANAGEMENT SYSTEM AND METHOD

(76) Inventors: Yasuhiro Fujii, Sagamihara (JP); Ryu Ebisawa, Yokohama (JP); Yutaka Tagawa, Yokohama (JP); Akira Morita, Yokohama (JP); Takuya Kusunoki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/324,906

(22) Filed: Nov. 28, 2008

(30) Foreign Application Priority Data
Jan. 7, 2008 (JP) 2008-000527

(51) Int. Cl. G06F 3/12

(52) U.S. Cl. 358/1.15

(57) ABSTRACT

A print management system is provided with a printer having a tag reader that reads a unique identifier of an IC tag attached to a medium, a log server that acquires information related to printing on the medium as a log, an ID management server that receives the identifier read by the tag reader, links the identifier to the time of printing on the medium or time at which the information of the IC tag is received and holds them in a storage and a print log integrating server that transmits the identifier of the IC tag attached to the medium to the ID management server, acquires the time at which the identifier is received from the ID management server, acquires logs in the vicinity of the time from the log server, links the log and the medium, stores and manages them in the storage.

### INCORPORATION BY REFERENCE

This application claims priority based on a Japanese patent application, No. 2008-000527 filed on Jan. 7, 2008, the entire contents of which are incorporated herein by reference.

### BACKGROUND OF THE INVENTION

The present invention relates to a print management system and a print management method, particularly relates to technique for linking a print and a print log equivalent to a history of printing and managing them.

The confirmation of whether print information is normally printed by a printer or not and further, the importance of ensuring the security of print information and a print are insisted. For one policy for it, the strict management of a print and a print log is proposed.

For example, JP-A No. 2006-203631 discloses a printer equivalent to a multi-function printer (MFP) having functions as a copying machine, a facsimile (FAX), a printer and others and provided with paper having RF ID in two or more locations of the rectangular paper so as to enable discrimination from jammed paper by writing a flag showing that the printing paper normally passes a paper carrier system of the MFP to the RF ID of the paper, a writer that writes information to the ID and a reader that reads the written information.

In the above-mentioned related art, to read the information from the RF ID of the printing paper or to write information to the RF ID, a special printer provided with a reader-writer of RF ID is required.

### SUMMARY OF THE INVENTION

The present invention provides technique for relating a printed medium and a print log and managing them with ease without greatly changing the existing operated printer and related programs.

The invention links a print and a print log respectively close in the time of printing and manages the linked result using an ID management server that manages an identifier of a medium and the time of printing on the medium and a print log integrating server that links a print log collected in a device as an information generation source such as a personal computer (PC) to the identifier of the medium.

A print management system according to the disclosed system is based upon a print management system that prints information generated in a device as an information generation source on a medium by a printer and outputs a print, and is provided with a printer having a tag reader that reads information of an IC tag having a unique identifier and attached to the medium, a log server that acquires and holds information related to printing on the medium in the printer from the device as the information generation source as a log, an ID management server that receives the identifier read by the tag reader of the IC tag, links the time of printing on the medium or time at which the information of the IC tag is received to the identifier of the IC tag and stores the linked result in a storage and a print log integrating server that transmits the identifier of the IC tag attached to the medium to the ID management server, acquires the time at which the identifier is received from the ID management server, acquires logs in the vicinity of the time from the log server, links the log and the medium and stores the linked result in the storage.

Besides, it is desirable that the print management system according to the disclosed system is based upon a print management system that prints information generated in a device as an information generation source on a medium by a printer and outputs a print, and is provided with the device as the information generation source that collects information related to time at which print information is spooled (spooled time information) when the print information is temporarily stored in a spool device of the printer, transmits the collected information to an ID management server, receives identification information from the ID management server, links the identification information to the print information and transfers the linked result to the printer, the printer that prints the print information and the identification information on the medium, the ID management server that generates unique identification information, links the spooled time information in the printer and the identification information and manages the linked result, a log server that acquires information related to the print information on the medium in the printer from the device as the information generation source as a log and holds it and a print log integrating server that transmits identification information printed on the medium to the ID management server, acquires spooled time information corresponding to the identification information held in the ID management server, acquires logs in the vicinity of the time from the log server, links the print log and the medium based upon the identification information and stores the linked result in a storage.

Besides, the disclosed system provides the special print log integrating server and further, the ID management server in the print management system.

The print log integrating server is based upon a server that manages a print log which is a print history generated in printing in a system that prints information generated in a device as an information generation source on a medium provided with an IC tag having a unique identifier and outputs a print, and is provided with an ID specifying unit that acquires the identifier of the IC tag attached to the medium and a range to be searched based upon the time of printing, a time acquiring unit that receives the identifier from the ID specifying unit and acquires time corresponding to the identifier, a print log acquiring unit that receives the time from the time acquiring unit, receives the range to be searched from the ID specifying unit, transmits them to a log server that manages print logs and acquires print logs in the range to be searched with the time in the center from the log server and an ID-print log linking unit that links the print log to the medium and outputs the linked result as a print log.

Besides, it is desirable that the ID management server is based upon a server that manages information related to a print log which is a print history generated in printing in a system that prints information generated in a device as an information generation source on a medium provided with an IC tag having a unique identifier and outputs a print, and is provided with a receiver that receives the identifier of the IC tag attached to the printed medium, a storage that receives the identifier from the receiver and stores it, a time acquiring unit that is activated when the storage stores the identifier, notifies the storage of time and instructs the storage to record the time as tag read time and a response unit that receives the identifier of the IC tag attached to the medium from an external device, acquires the tag read time corresponding to the identifier from the storage and sends the tag read time back.

Besides, it is desirable that at least two servers of the ID management server, the log server and the print log integrating server are configured on servers having common hardware.

It is desirable that a print log managing method according to the disclosed system is based upon a print log managing method for managing a log which is a print history generated in printing in a system that prints information generated in a device as an information generation source on a medium by a printer and outputs a print, and is provided with a step of reading information of an IC tag having a unique identifier and attached to the medium using a tag reader in printing, a step of acquiring information related to printing on the medium in the printer from the device as the information generation source as a log and storing the information in a log server, a step of receiving the identifier read by the tag reader of the IC tag, linking the time of printing on the medium or time at which the information of the IC tag is received to the identifier of the IC tag and storing the related result in a first storage, a step of acquiring the time at which the identifier of the IC tag attached to the medium is received from the first storage and acquiring logs in the vicinity of the time from the log server and a step of linking the acquired log and the medium and storing the linked result in a second storage.

Besides, it is desirable that a print log managing method according to the disclosed system is based upon a method of managing a log which is a print history generated in printing in a system that prints information generated in a device as an information generation source on a medium by a printer and outputs a print, and is provided with a step of collecting information related to time at which print information is spooled (spooled time information ) when the print information is temporarily stored in a spool device of the printer, transmitting the information to an ID management server, receiving identification information from the ID management server, linking the identification information to the print information and transferring the linked result to the printer, a step of printing the print information and the identification information on the medium, a step of generating unique identification information, linking the spooled time information in the printer and the identification information and managing the linked result in the ID management server, a step of acquiring information related to the print information on the medium in the printer from the device as the information generation source as a log and storing the information in a log server, a step of transmitting the identification information printed on the medium to the ID management server, acquiring the spooled time information corresponding to the identification information held in the ID management server and acquiring logs in the vicinity of the time from the log server and a step of linking the acquired print log and the medium based upon the identification information and storing the linked result in a storage.

According to the teaching herein, the print medium and a print log are linked without greatly altering the existing printer already operated and related programs such as a log collection program and can be managed.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 shows an example of the configuration of a print management system equivalent to one embodiment (a first embodiment);

FIG. 2 shows a process flow in the print management system;

FIG. 3A shows one example of print log information stored in a log server, FIG. 3B shows one example of ID information of a print stored in an ID management server, and FIG. 3C shows one example of a tag reader-printer correspondence table;

FIG. 4 shows a process flow related to a print log integrating server 50;

FIG. 5 is an explanatory drawing for explaining link between ID of a print and a print log;

FIG. 6 shows a format of a print log management table;

FIGS. 7A and 7B show examples of printers provided with each tag reader;

FIG. 8 shows an example of the hardware configuration of the tag reader;

FIG. 9 shows an example of the functional configuration of the ID management server 40;

FIG. 10 shows an example of the hardware configuration of the ID management server 40;

FIG. 11 shows an example of the functional configuration of the print log integrating server 50;

FIG. 12 shows an example of the configuration of a print management system equivalent to another embodiment (a second embodiment);

FIG. 13 shows an example of a process sequence to printing; and

FIG. 14 is an explanatory drawing for explaining a method of linking a log of printing spooling stored in the ID management server, ID of a print and a print log.

### DETAILED DESCRIPTION OF THE EMBODIMENTS

### First Embodiment

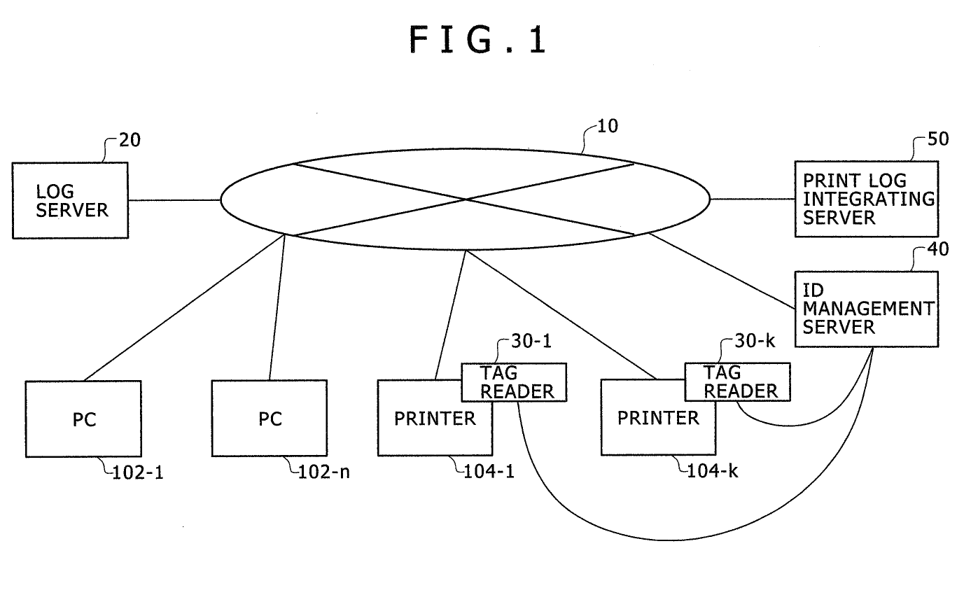

FIG. 1 shows an example of the configuration of a print management system equivalent to one embodiment.

The print management system includes a log server 20, an ID management server 40, a print log integrating server 50, plural “n” pieces of personal computers (PCs) 102-1 to 102-n (generically called 102) and plural “k” pieces of printers 104-1 to 104-k (generically called 104) respectively coupled to a communication network 10 such as an intranet. In this case, each printer 104 is provided with each tag reader 30-1 to 30-k (generically called 30)(in total, “k” pieces of tag readers) that reads information of an IC tag attached to printing paper (merely called paper).

The log server 20 is provided with a mass storage and is provided with a function for storing and managing a log of operation by a user generated in the PC 102 in the storage. For example, when a user X of the PC 102-1 instructs the printer 104-1 to print an electronic document A at time T, a log collection program (not shown) installed in the PC 102-1 collects log information for specifying printing action having relation to the PC 102-1, the user X, the electronic document A, the time T and the printer 104-1 and transmits the log information to the log server 20. The log server 20 stores the received log information. The log server 20 may also store other log information such as who and when output an electronic file B, copied it or deleted it.

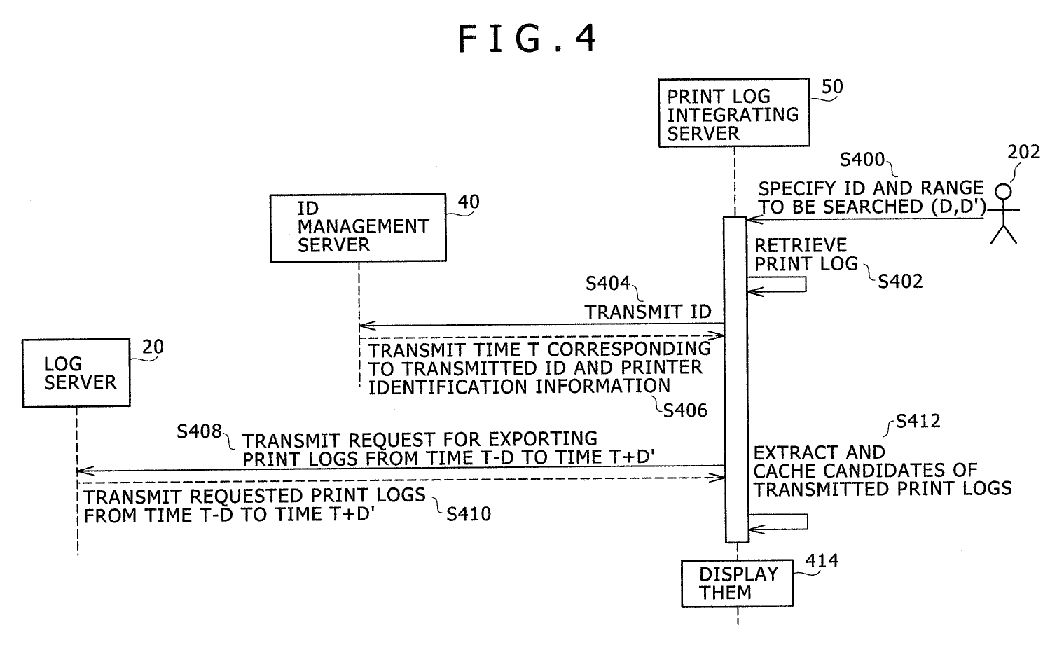

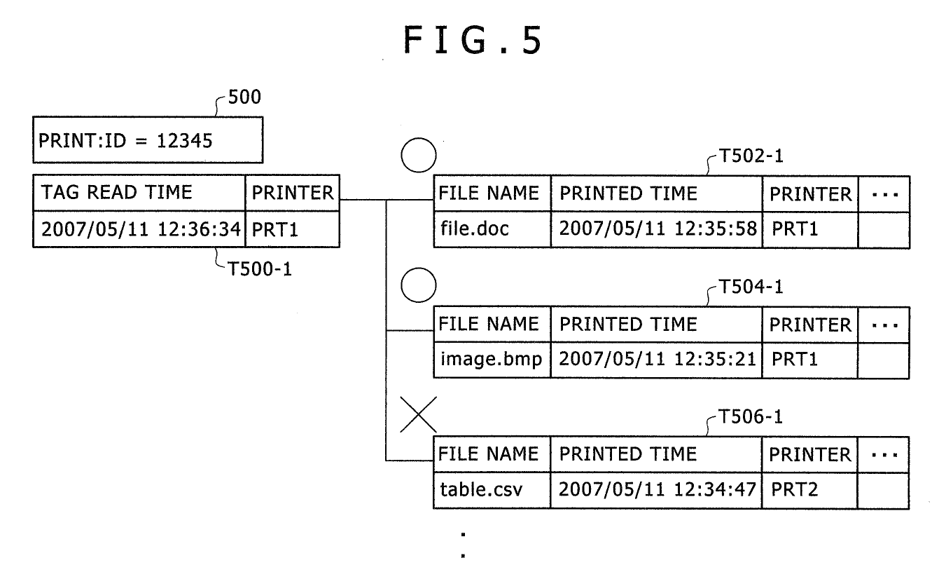

In this embodiment, as explained referring to FIGS. 4 and 5 later, it is premised that the log server 20 can export log information to an external PC and an external server. Further, it is significant that a print log stored in the log server 20 includes the time of printing.

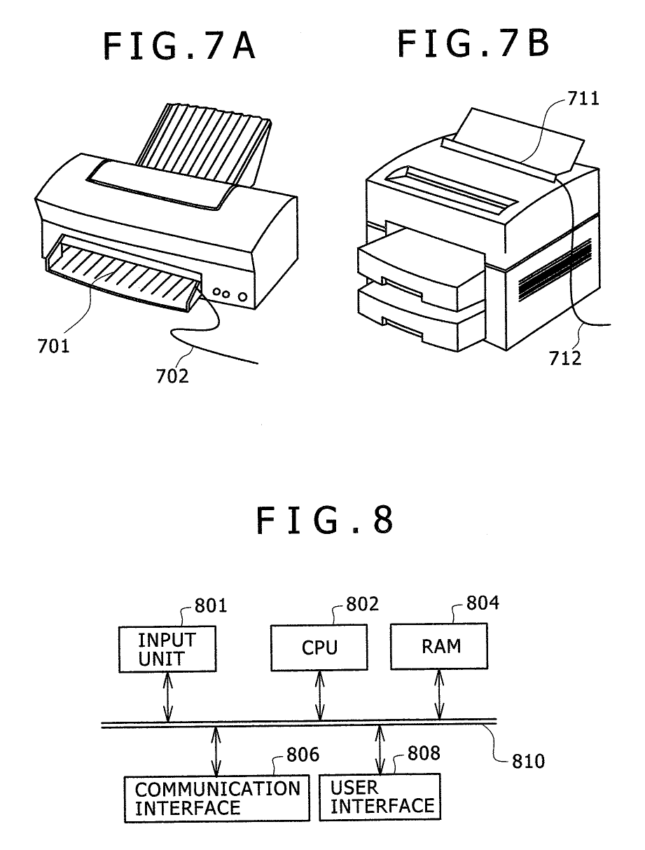

The tag reader 30 is installed at an ejection slot out of which paper is ejected of each printer 104. The tag reader 30 is provided with a function for reading an IC tag of paper and transmitting the read ID to the ID management server 40 when the paper with the IC tag set on a paper tray of the printer 104 is ejected. The hardware configuration of the tag reader will be described later referring to FIGS. 7A, 7B and 8.

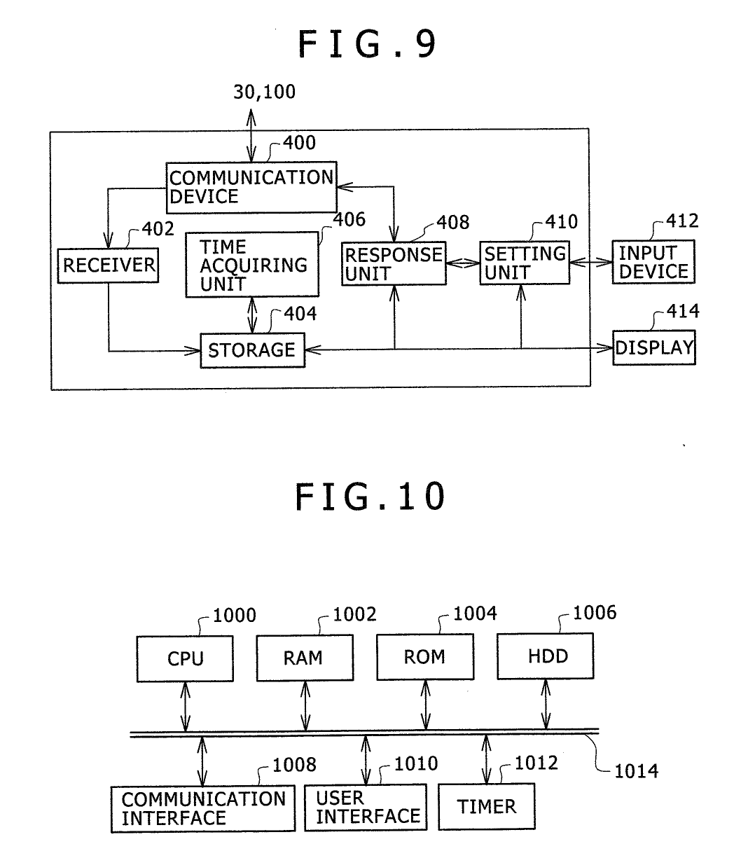

The ID management server 40 is provided with a function for managing the ID of the paper read by the tag reader 30. For example, the ID management server stores information that the paper to which the IC tag of ID12345 is attached is printed at the time T by the printer 104-1 (identification information PRT1 of the printer). The configuration of the ID management server 40 will be described later referring to FIGS. 9 and 10.

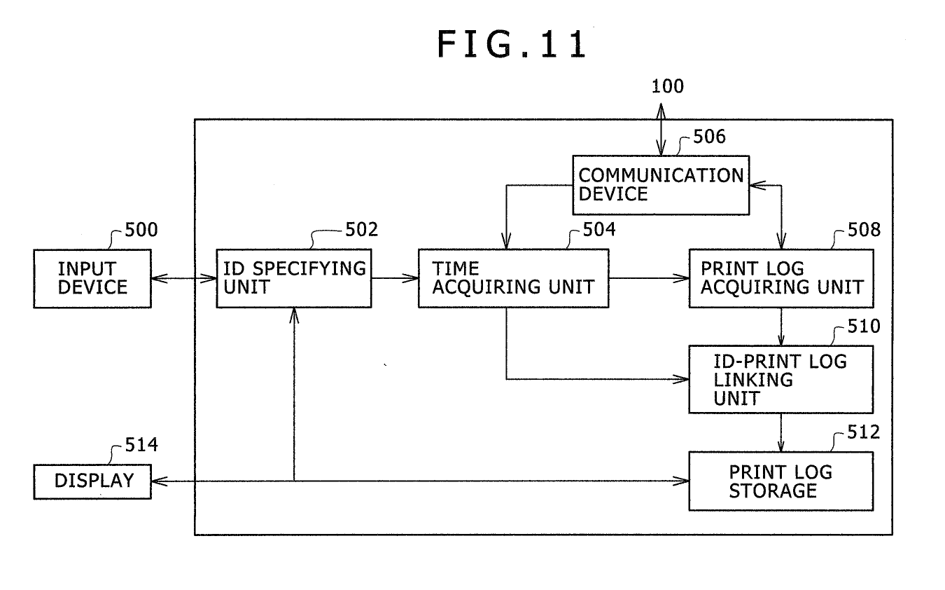

The print log integrating server 50 is provided with a function for managing information for linking a print log stored in the log server 20 and paper to which an IC tag is attached by communicating with the log server 20 and the ID management server 40. For example, the print log integrating server 50 links the print log that the user X of the PC 102-1 instructed the printer 104-1 to print the electronic document A at the time T and the ID of the paper to which the IC tag of ID12345 is attached. Hereby, it is held and can clearly demonstrated that the paper to which the IC tag of ID12345 is attached is the paper printed by the printer 104-1 instructed to print the electronic document A at the time T by the user X of the PC 102-1. The configuration of the print log integrating server 50 will be described later referring to FIG. 11.

As the log server 20 stores a file operation log of a user inside the PC 102, it is provided with no means for specifying a paper medium itself such as which paper is printed. For example, it is enabled by the related art disclosed in JP-A No. 2006-203631, however, in this case, a normal printer is required to be replaced with such a special printer as reads an IC tag from paper and notifies the PC and a log collection program of the PC is required to be replaced with a program that links a print log and received ID of paper. Therefore, the related art is not practical.

According to this embodiment, it can be realized to link and manage paper and a print log without replacing the existing printer already operated and the program for log collection.

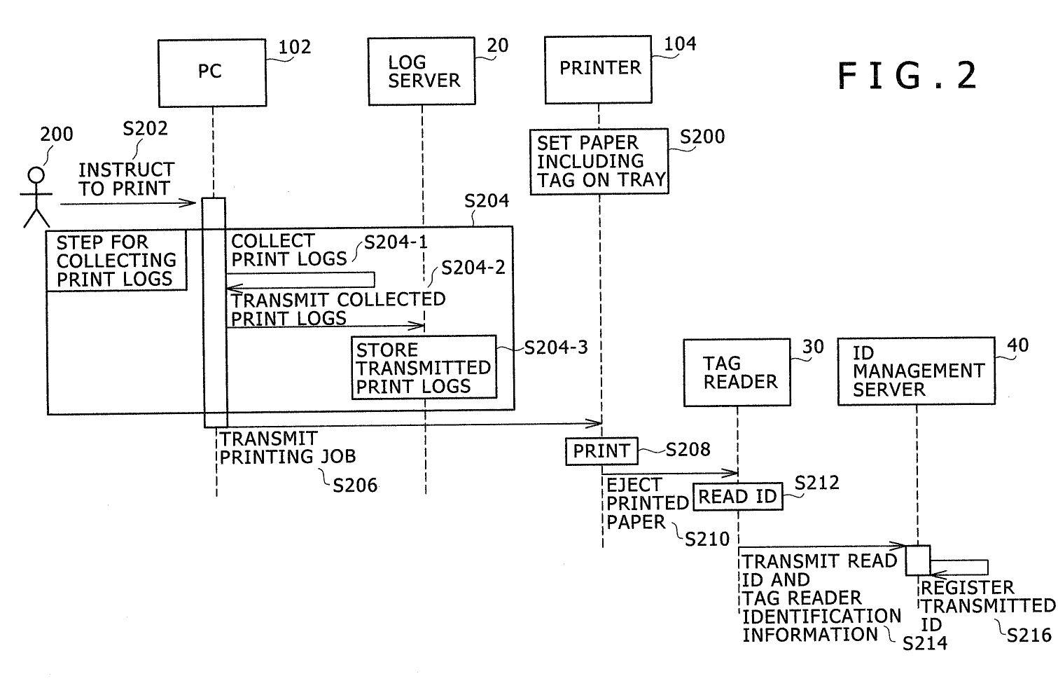

FIG. 2 shows a process flow in the print management system.

In particular, a process until ID is registered in the ID management server 40 is shown. Referring to FIG. 2, the process flow of the PC 102, the log server 20, the printer 104, the tag reader 30 and the ID management server 40 will be described below. A process in the print log integrating server 50 will be described later referring to FIGS. 4 and 5.

First, paper to which an IC tag is attached is set on the paper tray of the printer 104 (S200). In this embodiment, it is not required to be determined which paper is set in the printer by reading every IC tag beforehand. The reason is that the tag reader 30 reads ID when the printed paper is ejected and specifies the paper in a step S210 later.

When a user 200 of the PC 102 instructs to print data of an application program currently operated in a state in which the paper is set on the paper tray (S202), a step S204 for collecting a print log is executed. Operation for collecting a print log is not special itself and can be realized using the existing suitable technique. A characteristic of this embodiment is to collect information at least including the time of printing as a print log as described later referring to FIGS. 4 and 5.

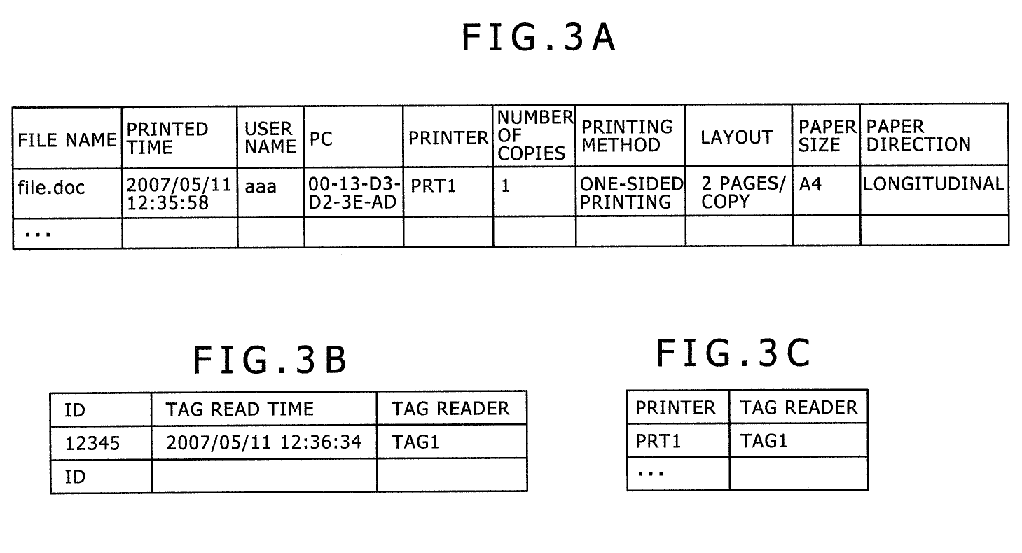

First, the PC 102 executes a log collection program collects a log related to printing (S204-1). The print log includes information such as a name of a file to be printed and printed time. Next, the PC 102 transmits the collected print log to the log server 20 (S204-2). The log server 20 stores the received print log in its storage (S204-3). The contents of the print log will be described later referring to FIGS. 3A to 3C. The step S204 related to the collection of the print log is finished.

Next, when the PC 102 transmits a printing job to the printer 104 (S206), the printer 104 receives the printing job and starts printing (S208). When the printing is finished, the paper is ejected (S210). When the paper passes through the ejection slot, the tag reader 30 reads ID of the IC tag of the paper (S212). The tag reader 30 transmits the read ID and identification information for uniquely specifying the tag reader to the ID management server 40 (S214). When reading the IC tag fails and no ID can be acquired, the tag reader transmits ID showing the failure of reading. It is desirable that the ID showing the failure of reading is defined beforehand and is set in the ID management server 40.

Finally, the ID management server 40 registers the received ID information and the tag reader identification information in its storage (S216). A format of the registration will be described later referring to FIG. 3B.

FIG. 3A shows one example of print log information T200 stored in the log server 20, FIG. 3B shows one example of ID information T400-1 of a print stored in the ID management server 40, and FIG. 3C shows one example of a tag reader-printer correspondence table T402.

As shown in FIG. 3A, the print log information T200 is stored in the log server 20. In this example, stored print log information includes a name of a file to be printed, printed time, a user name, an address of PC, a name of a printer, the number of copies, a method of printing (single-sided printing, double-sided printing and others), a layout (two pages/copy and others), paper and a direction of the paper.

It is recognized based upon the print log information T200 that the printer PRT1 was instructed to print the file “file.doc” in single-sided printing by one copy by a user “aaa” via the PC having an address of “00-13-D3-D2-3E-AD” and the file was printed with A4 paper vertically directed so that two pages are settled in one piece of paper at 12:36:34 on May 11, 2007. Every time a printing process is executed, such print log information is added to the log server 20. In this embodiment, as shown in FIG. 5, it is significant that a print log includes the time of printing.

As shown in FIG. 3B, the ID information T400-1 is ID information of a print stored in the ID management server 40. In this example, the ID management server 40 stores ID of an IC tag attached to paper, time at which the IC tag is read and tag reader identification information. It is recognized based upon ID information T400-1 that the IC tag fixed to the paper of ID 12345 is read at 12:36:34 on May 11, 2007 by a tag reader TAG1.

The tag reader-printer correspondence table T204 is information stored in the ID management server 40 so as to manage link between the tag reader and the printer. This example shows that the tag reader TAG1 is installed in the printer PRT1 (the printer 104-1). It is recognized by using the tag reader-printer correspondence table T402 and the ID information T400-1 together that the paper to which the IC tag of ID12345 is attached was ejected from the printer PTR1.

Though the following is described later referring to FIG. 5, it is desirable that identification information of the printer managed in the tag reader-printer correspondence table T402 has the same format as printer identification information in a print log managed in the log server 20. For example, when a list of the print log information T200 is managed based upon names of the printers, the printer identification information in the correspondence table T402 is also set based upon names of the printers and the ID management server 40 is designed so that the same printer has the same identification information.

FIG. 4 shows a process flow related to the print log integrating server. Referring to FIG. 4, processing operation among the log server 20, the ID management server 40 and the print log integrating server 50 will be described below.

First, the user 202 that operates the print log integrating server 50 specifies ID of paper a print log of which is to be retrieved and a range to be searched (D,D′) required for linking the print log and the ID of the paper (S400). That is, the user instructs the tag reader to read an IC tag attached to the paper and specifies the read ID. Or the user may also specify the ID by coupling the tag reader to the print log integrating server 50 and transferring ID of the IC tag read by the tag reader to the print log integrating server 50. The range to be searched (D,D′) will be described in the following steps S408 and S410.

Next, the print log integrating server 50 retrieves a print log storage 512 with which the print log integrating server 50 is provided and which caches print logs based upon the ID and the range to be searched (D, D′) respectively specified by the user 202 and extracts the corresponding print log. As a result, when the corresponding print log is found, the print log integrating server displays the print log on a display and finishes the process. In the meantime, when the corresponding print log is not found, the following processing steps are executed.

Next, the print log integrating server 50 transmits the ID specified by the user 202 to the ID management server 40 (S404). The ID management server 40 transmits tag read time T corresponding to the received ID and printer identification information to the print log integrating server 50 (S406). For example, when the print log integrating server 50 transmits ID12345 in the step S404, the ID management server 40 collates a list of the ID information T400-1 shown in FIG. 3B and the tag reader-printer correspondence table T402, and transmits the tag read time, 12:36:34 on May 11, 2007 and the printer name PRT1.

Afterward, the print log integrating server 50 transmits a request for exporting a print log to the log server 20 (S408). In the concrete, the print log integrating server requests the log server 20 to export print logs from time T−D to time T+D′ using the tag read time T received in the step S406 and the range to be searched (D,D′) specified by the user 202 in the step S400. When some authentication such as ID, a password and device authentication is demanded in the exportation, authentication is made before the step S408 and a communication session is established between the log server 20 and the print log integrating server 50. As the authentication itself digresses from the subject of the invention, the description is omitted.

The log server 20 retrieves the print logs from the time T−D to the time T+D′ in response to the request in the step S408 and transmits them to the print log integrating server 50 (S410). When a communication session is established before the step S408, the print logs are released after they are transmitted.

The print log integrating server 50 receives the print logs and extracts a candidate of the print log corresponding to the ID of a print specified by the user 202 from the print logs (S412). A method of extracting will be described later referring to FIG. 5. The extracted print log is cached in the print log storage 512 in the print log integrating server 50 to enable retrieval in the step S402.

Finally, the print log integrating server 50 displays a list of candidates of the extracted print logs (S414). When no print log exists, the print log integrating server displays a message that no print log exists.

For a transformed example of the above-mentioned example, in place of the user 202 specifying ID of a print, the user 202 sets a largish range to be searched (D,D′) beforehand, the print log integrating server 50 periodically generates ID, executes the processing of the steps S402 to S412, communicates with the log server 20 and the ID management server 40, prepares a list of print log information corresponding to various IDs, and may also cache the list in the print log storage. In this case, there is an advantage that a print log can be immediately extracted in the step S402 even if the print log integrating server 50 does not communicate with the log server 20 or the ID management server 40. However, when the range to be searched (D,D′) is too large and the print log storage overflows, it is desirable that the user 202 erases the cache, sets the range to be searched (D,D′) to a smaller range, and instructs to execute the processing of the steps S402 to S412 again.

For another transformed example, the print log integrating server 50 is not necessarily required to be provided with the print log storage. In this case, the print log integrating server 50 omits the retrieval of a print log in the step S402 and immediately executes the processing of the step S404. In this case, candidates of print logs are not cached in the step S412. According to this example, as no print log storage exists, the mounting cost of the print log integrating server 50 can be reduced.

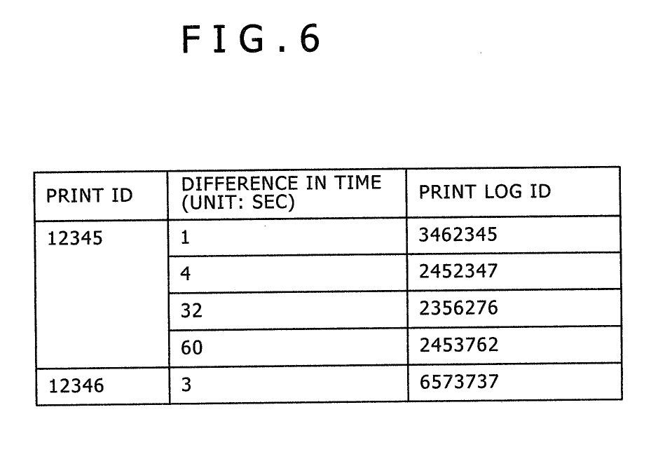

Next, referring to FIGS. 5 and 6, linking ID of a print and a print log in the print log integrating server 50 will be described.

As described referring to FIG. 4, the print log integrating server 50 acquires information T500-1 (the tag read time T and printer identification information corresponding to paper 500 of ID12345) received from the ID management server 40 and print logs T502-1, T504-1 and T506-1 from the time T−D to the time T+D′ when a range to be searched is (D,D′). In an example shown in FIG. 5, the tag read time of the paper 500 of ID12345 is 12:36:34 on May 11, 2007, printed time in the print log T502-1 is 12:35:58 on May 11, printed time in T504-1 is 12:35:21 on May 11, and printed time in T506-1 is 12:34:47 on May 11. As a range to be searched specified beforehand is (0 min., 2 min.), print logs from 12:34:34 on May 11, 2007 to 12:36:34 on May 11 are acquired.

A characteristic of this embodiment is that a log corresponding to a print can be found out among a large number of print logs stored in the log server 20 by linking the print and the print log based upon tag read time and the time of printing in the print log without requiring a special log server and a special printer. An example shown in FIG. 5 means that the print output in a printing process recorded in the print logs T502-1, T504-1 and T506-1 corresponds to the paper to which the IC tag of ID12345 is attached. That is, it is shown that the corresponding print is paper on which any of files “file.doc”, “image.bmp” and “table.csv” is printed.

Further, as printer identification information is also included in the information T500-1 received from the ID management server 40 when the log server 20 can also acquire a name of the printer that prints as a print log, print logs corresponding to the print can be limited more by removing print logs different in printer identification information. In the example shown in FIG. 5, the name of the printer in the information T500-1 is PRT1, however, only a name of the printer in the print log T506-1 is PRT2. Therefore, it is shown that the print log T506-1 actually has no relation to the print 500. To limit based upon printer identification information, the ID management server 40 is designed so that printers are managed based upon their names in an example of the tag reader-printer correspondence table T402 shown in FIG. 3C.

FIG. 6 shows an example of the configuration of a print log management table managed by the print log integrating server 50. This management table holds difference between time at which a print log is acquired and actually read time by the tag reader and print log ID which is ID of each line of the print log information T200 corresponding to ID of a print.

In this example, print ID and print log ID within 60 seconds in the difference between the print log acquired time and the tag reader read time are acquired from the ID management server 40 and the log server 20, respectively, and are held in the management table. There are four print log IDs linked to the print ID 12345 and the time differences among them are 1, 4, 32 and 60 seconds. There is only one print log ID linked to print ID 12346 and the time difference is 3 seconds.

As described above, when the time of printing and printer identification information as a print log can be acquired, a print and a print log can be linked by further using them. Hereby, paper and a print log can be linked without replacing a printer and a log collection program.

When printing fails because of a paper jam, the shortage of paper and others and a print log is stored in the log server 20 by mistake though the printing fails, the log of failed printing which originally has nothing with a print may be linked to the print according to this embodiment. However, an object of the embodiment is not to strictly link a print and a print log in one-to-one correspondence but to extract candidates from a large number of print logs stored in the log server 20 without exception, and the expected object is achieved by collating based upon the time of printing. If the candidates are to be strictly linked, a user has only to compare the actual content of a file and the content of the print using the candidates of print logs.

When printing is delayed because of the replacement of paper and toner and others, no print log really corresponding to a print may be found according to this embodiment. Then, when this embodiment is applied, it is desirable that a largish range to be searched (in units of one day) is specified in consideration of an operational common sense that the delay of printing does not last for a few days. Even if the range to be searched is extended, it is unchanged that a large number of logs stored in the log server 20 can be limited.

FIGS. 7A, 7B and 8 show printers provided with tag readers and their hardware configuration.

FIG. 7A shows an example of a printer in which paper is ejected onto a tray on the downside and FIG. 7B shows an example of a printer in which paper is ejected onto a tray on the upside from a paper tray.

Tag readers 701, 711 are installed inside ejection slots of the respective printers. The reason why each tag reader is installed inside each ejection slot is to read an IC tag only once when paper passes through each ejection slot. The reason is also to prevent the IC tag from being repeatedly read by mistake because each tag reader 701, 711 reacts when prints are ejected and are piled on the tray.

Communication cables 702, 712 are cables for transmitting read ID to the ID management server 40. When the tag readers 701, 711 are provided with a radio communication facility and can transmit read ID by radio, the cables 702, 712 are not required.

FIG. 8 shows the hardware configuration of the tag reader 30.

The tag reader 30 is provided with an input unit 801, CPU 802, RAM 804, a communication interface 806 and a user interface 808. This hardware is coupled via a hub 810.

The input unit 800 is a unit for reading an IC tag. The CPU 802 is hardware for operation and the RAM 804 is a memory for temporarily storing read ID. The communication interface 806 is hardware for controlling wire communication or radio communication and transmits read ID or a signal showing the failure of reading to the ID management server 40 and the print log integrating server 50.

The user interface 808 is hardware for receiving an instruction from a user to start reading an IC tag and displaying read ID. In an example shown in FIGS. 7A and 7B, as the tag reader is always ready to read an IC tag and is not required to display read ID, the user interface 808 is not required. As described later referring to FIG. 11, the user interface 808 is used when ID of an IC tag attached to paper is notified the print log integrating server 50.

FIGS. 9 and 10 show a function and the hardware configuration of the ID management server 40.

The ID management server 40 is provided with a communication device 400, a receiver 402, a storage 404, a time acquiring unit 406, a response unit 408 and a setting unit 410. The input device 412 and a display 414 are coupled to the ID management server 40.

The communication device 400 provides a communication facility between the tag reader 30 and the print log integrating server 50 or the ID management server 40 such as receives ID from the tag reader 30 in the step S214 shown in FIG. 2, receives ID of paper in the step S404 shown in FIG. 4 and transmits information of tag read time and others to the print log integrating server 50 via the network 100 in the step S406.

The receiver 402 receives the ID of the paper and tag reader identification information from the tag reader 30 via the communication device 400 in the step S214 shown in FIG. 2 and transfers them to the storage 406.

The storage 404 stores the ID of the paper and the tag reader identification information respectively transferred by the receiver 402 in the step S216 shown in FIG. 2. The time acquiring unit 406 is activated when the storage 406 registers the ID and the tag reader identification information in the step S216 shown in FIG. 2 and notifies the storage 406 of time. The storage 406 registers the time as tag read time.

The response unit 408 receives the ID from the print log integrating server 50 via the communication device 400 in the step S404 shown in FIG. 4, acquires the tag read time and the printer identification information respectively corresponding to the corresponding ID from the storage 406, and sends them back. The printer identification information is judged based upon tag identification information, referring to the tag reader-printer correspondence table T402 shown in FIG. 3C stored in the setting unit 410. The setting unit 410 stores the tag reader-printer correspondence table T402. The input device 412 functions as a device for a user to enter in the tag reader-printer correspondence table T402. The display 414 functions as a device for a user to read information stored in the storage 404 and the setting unit 410.

Next, referring to FIG. 10, the hardware configuration of the ID management server 40 will be described.

The ID management server 40 is provided with a CPU 1000, a RAM 1002, a ROM 1004, a HDD 1006, a communication interface 1008, a user interface 1010 and a clock 1012. These hardware is coupled via a hub 1014.

The CPU 1000 is hardware for operation and the RAM 1002 is a memory for temporarily storing data. The ROM 1004 is a non-volatile memory and stores a program for controlling the operation of the receiver 402, the storage 404, the time acquiring unit 406, the response unit 408 and the setting unit 410.

The HDD 1006 is a record medium for holding data which the storage 404 and the setting unit 410 store. A program for controlling the operation of the receiver 402 and others may be also provided in place of the ROM 1004. The communication interface 1008 is an interface for administering communication and corresponds to the communication device 400.

The user interface 1010 is a user interface for controlling an input system including a mouse and a keyboard, and a display system including a display, and facilitates functions of the input device 412 and the display 414.

The clock 1012 is hardware for synchronizing the operation of the units in the ID management server 40 via the hub 1014 and also corresponds to the time acquiring unit 406.

FIG. 11 shows an example of the hardware configuration of the print log integrating server 50.

The print log integrating server 50 is provided with an ID specifying unit 502, a time acquiring unit 504, a communication device 506, a print log acquiring unit 508, an ID-print log linking unit 510 and a print log storage 512. An input device 500 and a display 514 are coupled.

The input device 500 such as a keyboard is a device for the user 202 to notify the ID specifying unit 502 of the print log integrating server 50 of ID of paper a print log of which is to be retrieved and a range to be searched in the step S400 shown in FIG. 4. The tag reader may be also coupled to the input device to input ID of paper.

The tag reader reads an IC tag fixed to a print by the operation of the user 202 and transmits the read ID to the ID specifying unit 502.

The ID specifying unit 502 receives the ID of the paper and the range to be searched from the input device 500 such as a keyboard and the tag reader, extracts the corresponding print log from the print log storage 512 in the step S402 shown in FIG. 4, and displays the print log on the display 514. When no corresponding print log exists, the ID specifying unit transfers the received ID of the paper and the received range to be searched to the time acquiring unit 504.

The time acquiring unit 504 transmits the ID of the paper received from the ID specifying unit 502 to the ID management server 40 via the communication device 506 in the step S404 shown in FIG. 4 and receives time and printer identification information respectively linked to the corresponding ID in the step S406 shown in FIG. 4. After the reception, the time acquiring unit 504 transmits the received time and the received range to be searched to the print log acquiring unit 508. The time acquiring unit also transmits the ID and the printer identification information to the ID-print log linking unit 510.

The communication device 506 provides facilities to communicate with the ID management server 40 and the print log integrating server 50 via the network 10. The print log acquiring unit 508 transmits the time and the range to be searched respectively provided by the time acquiring unit 504 to the log server 20 via the communication device 506 in the step S408 shown in FIG. 4 and receives a print log in the range to be searched from the log server 20 in the step S410 shown in FIG. 4. The print log acquiring unit transmits the received print log to the ID-print log linking unit 510.

The ID-print log linking unit 510 calculates link described referring to FIG. 5 between the ID of the paper and the print log in the step S412 shown in FIG. 4 and transmits the result to the print log storage 512. The print log storage 512 registers information received from the ID-print log linking unit 510 for relating the ID of the paper and the print log in the step S412 shown in FIG. 4. The display 514 displays the information registered in the print log storage 512.

The hardware configuration of the print log integrating server 50 is substantially similar to that of the ID management server 40 and is provided with CPU, RAM, ROM, HDD, a communication interface, a user interface, a clock and a hub that couples these units.

In the above-mentioned embodiment, the ID management server 40, the print log integrating server 50 and the log server 20 have the same hardware configuration and are different in a program for realizing their functions. According to a transformed example, each server may be also realized by configuring these three servers or some two servers by common hardware configuration and executing a program for realizing functions of the two or three servers.

### Second Embodiment

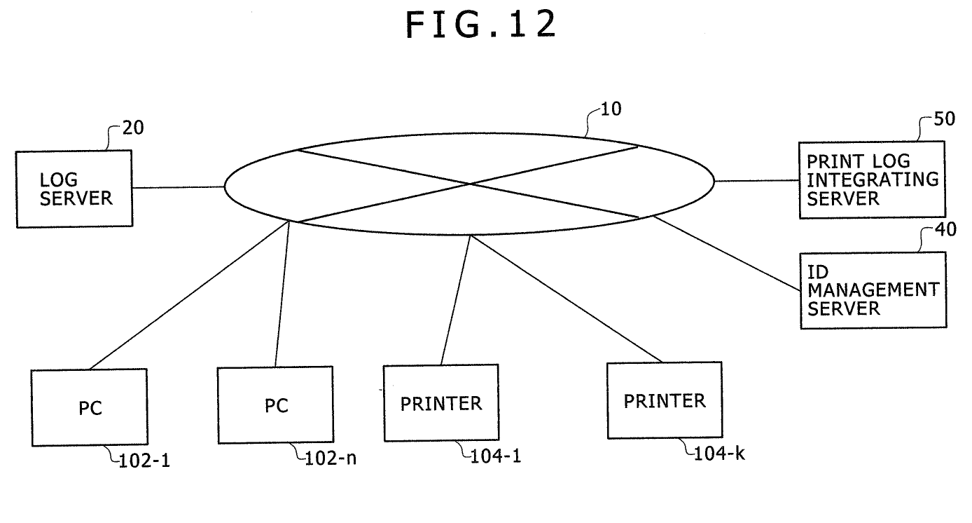

FIG. 12 shows the configuration of a print management system equivalent to a second embodiment.

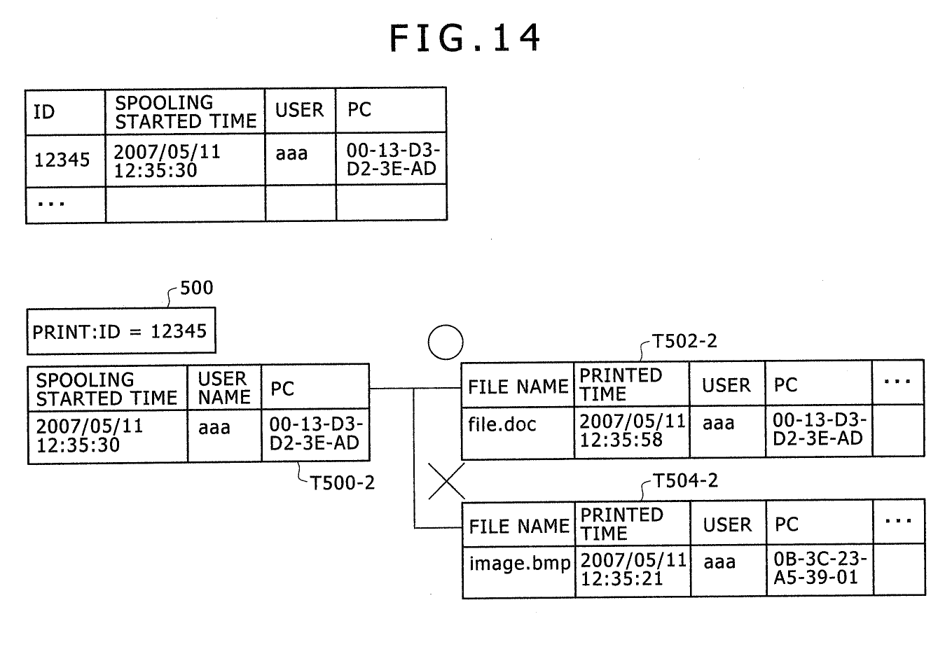

This print management system is different from the system shown in FIG. 1 in the first embodiment in that no tag reader 30 is provided. In this embodiment, ID of a print is managed by directly writing ID to print data in place of reading the ID of paper using the tag reader. According to this embodiment, as no tag reader is provided, the cost can be reduced, compared with the system in the first embodiment and as described later referring to FIG. 14, a print and a print log are more precisely linked.

A log server 20 is provided with a function for storing a log of operation by a user in PC 102. In this embodiment, as in the first embodiment, it is premised that the log server 20 can export stored log information to external PC and an external server. Further, it is premised that a print log stored in the log server 20 includes at least the time of printing.

Normal printing paper to which no IC tag is attached is set on a paper tray of a printer 104. Differently from the first embodiment, in this embodiment, ID of paper is managed by writing the ID to print data by the PC 102 in printing.

A print log integrating server 50 is provided with a function for managing information for linking a log stored in the log server 20 and a print.

According to this embodiment, a function for linking paper and a print log can be added to the existing printer and the existing log collection program respectively already operated by installing a program for collecting logs of printing spooling in the PC 102 instead without replacing the printer and the program and without preparing a tag reader and paper to which an IC tag is attached.

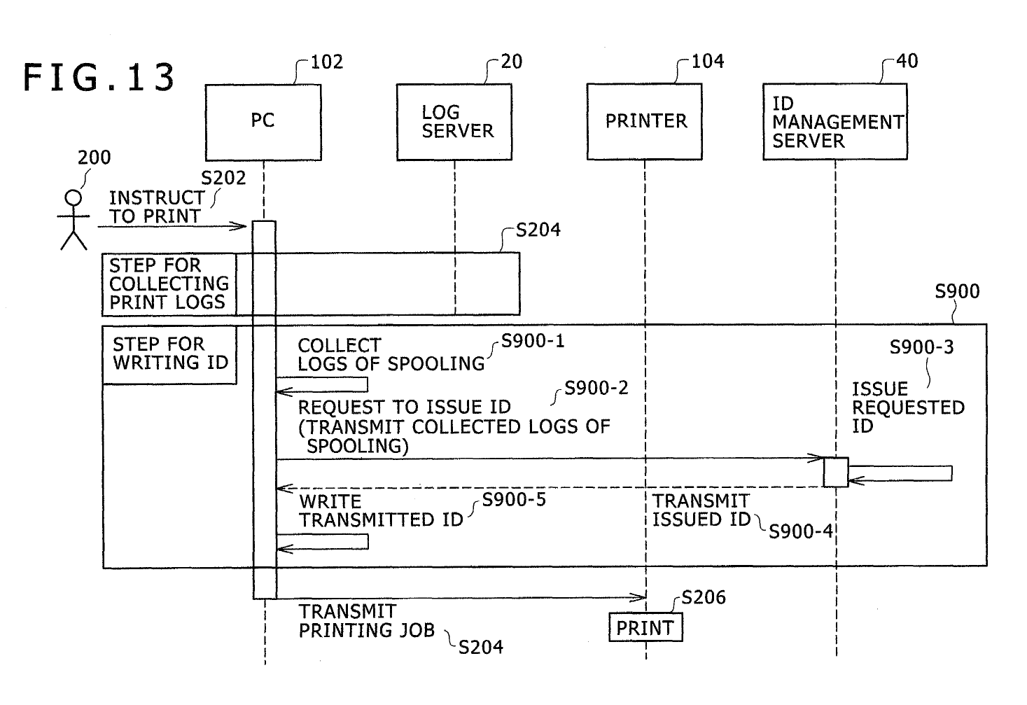

FIG. 13 shows a processing sequence to printing in a process flow in the second embodiment.

Referring to FIG. 13, processing in the PC 102, the log server 20, the printer 104 and an ID management server 40 will be described below. Processing in the print log integrating server 50 will be described later referring to FIG. 14.

First, the user 200 of the PC 102 instructs the printer to print data in an application program currently operated (S202). Next, a print log is collected (S204). This processing step is similar to the operation in FIG. 2. The print log is stored in the log server 20. Simultaneously, the data in the application program is converted to data in a data format which the printer 104 can interpret and is temporarily stored in a printing spool device in the PC 102.

A group of steps S900 is a process for writing ID to paper. In normal printing, print data stored in the printing spool device is transmitted to the printer 104, however, in this embodiment, print data is queued in the printing spool device until the writing of the ID to the print data in the step S900-5 is completed.

First, the PC 102 instructs the spooling log collection program (not shown) to collect log information related to printing spooling (S900-1). Collectable log information includes time at which spooling is started, identification information of the PC 102 and a name of a user that logs in. When a format of print data is known, information such as printer identification information and the number of sets can be further also acquired by analyzing the format. Though the following is described later referring to FIG. 14, it is premised that at least the spooling started time is collected as a log of spooling.

Next, the PC 102 transmits a request for issuing ID to be written to print data to the ID management server 40 (S900-2). In the concrete, the PC transmits the logs of spooling collected in the step S900-1. Then, the ID management server 40 registers the received log information of printing spooling and issues the ID corresponding to this in one-to-one correspondence (S900-3). The ID management server 40 transmits the issued ID to the PC 102.

The PC 102 writes the received ID to the print data queued in the printing spool device (S900-5). When a format of the print data is known, the PC writes the ID by altering the print data. When the format is unknown, the ID has only to be written after the format of the print data is converted to a format easy to handle such as an image beforehand. As for the conversion of print data to an image, normally known technique has only to be used.

For a method of representing ID, there are a method of overwriting a number of ID to a header, a footer or a background of print data so as to enable a user to read it, a method of converting ID to a bar code and adding it to a corner, digital watermarking technique for embedding information by subtly altering the whole print data so as to be barely perceived by human eyes and tint block watermarking technique for embedding information by adding minute dots to a background of print data.

Processing related to the writing of the ID is finished. Finally, the PC 102 transmits the print data to which the ID is written to the printer 104 as a print job (S204), the printer prints the received print job (S206), and the whole process is completed.

FIG. 14 is a conceptual drawing for explaining a log of printing spooling stored in the ID management server 40 and a method of relating ID of a print and a print log in the second embodiment.

In the step S900-3 shown in FIG. 13, the ID management server 40 registers the log information of printing spooling received from the PC 102 and issues ID corresponding to this in one-to-one correspondence. The ID management server 40 stores the received log of spooling in a format of a printing spooling log list T400-2. In this example, as a log of spooling, 12:35:30 on May 11, 2007 as spooling started time, aaa as a user name and “00-13-D3-D2-3E-AD” as an address of PC are stored, and it is shown that corresponding ID is 12345.

A method of linking a print log and ID of paper in the print log integrating server 50 is the same as the method shown in FIG. 4. In an example shown in FIG. 14, the print log integrating server 50 acquires print logs T502-2 and T504-2 from time T−D to time T+D′ according to information T500-2 (spooling started time T, a user name and an address of PC respectively corresponding to a print 500 of ID12345) received from the ID management server 40 and a range to be searched (D,D′) specified by a user.

When the log server 20 can also acquire the user name and the address of PC as a print log, print logs corresponding to the print can be limited more by excluding print logs which do not coincide with the log of spooling T500-2 received from the ID management server 40. In the example shown in FIG. 14, an address of PC in the information T500-2 is “00-13-D3-D2-3E-AD”, however, an address of PC in the print log T504-2 is “0B-3C-23-A5-39-01” and is different from the address in the information T500-2. Therefore, it is shown that the print log T504-2 really has no relation to the print 500.

To limit a print log based upon the log of spooling as described above, the spooling log collection program is required to be designed so that the log of spooling acquired in the step S900-1 shown in FIG. 13 is as equivalent to a log collected by the log server 20 as possible. For example, when not an address of PC (an address on a network) but an IP address is collected as a print log by the log server 20, the spooling log collection program is altered so that the IP address of the PC is acquired as a log of spooling.

The ID management server 40 is provided with the same function and the same hardware configuration as those of the ID management server 40 shown in FIGS. 9 and 10, however, the ID management server 40 is different in that a receiver 402 receives a log of spooling, registers it in a storage 404 and returns ID issued by the storage 404 to PC 102 in the step S900-3 shown in FIG. 13.

The print log integrating server 50 is also provided with the same function and the same hardware configuration as those shown in FIG. 11, however, the print log integrating server is different from that in the first embodiment in that a print log is limited using a log of spooling in place of printer identification information in the ID-print log linking unit 510.

When the time of printing and a log related to printing spooling as a print log can be acquired, a print and the print log can be linked by further using these. As described above, according to this embodiment, paper and a print log can be linked without replacing a printer and a log collection program.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A print management system that prints information generated in a device as an information generation source on a medium by a printer and outputs a print, comprising:
the printer provided with a tag reader that reads information of an IC tag having a unique identifier and attached to the medium;
a log server that acquires information related to printing on the medium in the printer from the device as the information generation source as a log and holds it;
an ID management server that receives the identifier read by the tag reader of the IC tag, links the time of printing on the medium or time at which the information of the IC tag is received to the identifier of the IC tag and holds the linked result in a storage; and
a print log integrating server that transmits the identifier of the IC tag attached to the medium to the ID management server, acquires the time at which the identifier is received from the ID management server, acquires logs in the vicinity of the time from the log server, links the log and the medium and stores the lined result in a storage.

2. The print management system according to claim 1, wherein identification information of the printer instructed to print is included in the log related to printing and collected by the log server;
the ID management server is provided with a correspondence table showing link between identification information for identifying the tag reader and an identifier for identifying the printer in which the tag reader is installed in the storage;
the identifier managed in the correspondence table of the printer has the same format as the identification information collected in the log server of the printer instructed to print;
the ID management server converts the identifier unique to the medium and notified from the tag reader of the IC tag, the time at which the identifier is received and identification information of the tag reader to the identification information of the printer based upon the correspondence table and stores it in the storage; and
the print log integrating server transmits the identifier of the IC tag attached to the medium to the ID management server, receives the time at which the identifier is received and the identification information of the printer from the ID management server, acquires print logs in the vicinity of time at which the identification information is received from the log server, links the print log including a printer which coincides with the identification information of the printer among the print logs to the medium and manages them.

3. The print management system according to claim 1,
wherein the ID management server is provided with:
a receiver that receives the identifier of the IC tag attached to the medium from the tag reader;
the storage that receives the identifier from the receiver and stores it;
a time acquiring unit that is activated when the storage stores the identifier, notifies the storage of the time and instructs the storage to record the time as tag read time; and
a response unit that receives the identifier of the IC tag attached to the medium from the print log integrating server, acquires tag read time corresponding to the identifier from the storage and sends it back.

4. The print management system according to claim 1,
wherein the print log integrating server is provided with:
an ID specifying unit that acquires the identifier of the IC tag attached to the medium and a range to be searched based upon the time of printing;
a time acquiring unit that receives the identifier from the ID specifying unit, transfers it to the ID management server and acquires time corresponding to the identifier;
a print log acquiring unit that receives the time from the time acquiring unit, receives the range to be searched from the ID specifying unit, transmits them to the log server and acquires print logs in the range to be searched with the time in the center from the log server; and
an ID-print log linking unit that links the print log to the medium and outputs it as the print log.

5. The print management system according to claim 1,
wherein the print log integrating server is provided with:
an ID specifying unit that acquires the identifier of the IC tag attached to the medium and a range to be searched based upon the time of printing;
a time acquiring unit that receives the identifier from the ID specifying unit, transfers it to the ID management server and acquires time corresponding to the identifier and identification information of the printer;
a print log acquiring unit that receives the time and the identification information of the printer from the time acquiring unit, receives the range to be searched from the ID specifying unit, transmits them to the log server and acquires print logs in the range to be searched with the time in the center from the log server; and
an ID-print log linking unit that outputs the print logs including the printer coincident in identification information among the print logs as a print log linked to the medium.

6. The print management system according to claim 4,
wherein the print log integrating server is further provided with a print log storage that stores information for linking the medium and the print log respectively lined by the ID-print log linking unit; and
when the ID specifying unit receives the identifier of the IC tag attached to the medium and the range to be searched based upon the time of printing, the ID specifying unit searches a print log corresponding to the identifier and the range to be searched in the print log storage, outputs the print log as a print log linked to the medium when the print log exists as a result and transmits the corresponding identifier to the time acquiring unit when no print log exists.

7. A print management system that prints information generated in a device as an information generation source on a medium by a printer and outputs a print, comprising:
the device as the information generation source that collects information related to time at which print information is spooled (spooled time information) when the print information is temporarily stored in a spool device of the printer, transmits the information to an ID management server, receives identification information from the ID management server, links the identification information to the print information and transfers the linked result to the printer;
the printer that prints the print information and the identification information on the medium;
the ID management server that generates unique identification information, links the spooled time information in the printer and the identification information and manages the linked result;
a log server that acquires and holds information related to the print information on the medium in the printer from the device as the information generation source as a log; and
a print log integrating server that transmits the identification information printed on the medium to the ID management server, acquires the spooled time information corresponding to the identification information held in the ID management server, acquires logs in the vicinity of the time from the log server, links the print log and the medium based upon the identification information and stores the linked result in a storage.

8. The print management system according to claim 7,
wherein the device as the information generation source collects spooling started time and a log related to print data temporarily stored in the spool device and transmits them to the ID management server;
the ID management server receives the log, issues corresponding identification information and manages it; and
the print log integrating server transmits the identification information printed on the medium to the ID management server, receives the spooling started time corresponding to the identification information and the log related to the print data from the ID management server, acquires print logs in the vicinity of the time from the log server, links the print log including information related to the log regarding the print data among the print logs to the medium and stores the linked result in the storage.

9. The print management system according to claim 1,
wherein at least two servers out of the ID management server, the log server and the print log integrating server are configured on servers having common hardware.

10. A server that manages a print log which is a print history generated in printing in a system that prints information generated in a device as an information generation source on a medium provided with an IC tag having a unique identifier and outputs a print, comprising:
an ID specifying unit that acquires the identifier of the IC tag attached to the medium and a range to be searched based upon the time of printing;
a time acquiring unit that receives the identifier from the ID specifying unit and acquires time corresponding to the identifier;
a print log acquiring unit that receives the time from the time acquiring unit, receives the range to be searched from the ID specifying unit, transmits them to a log server that manages a print log and acquires print logs in the range to be searched with the time in the center from the log server; and
an ID-print log linking unit that links the print log to the medium and outputs the linked result as a print log.

11. A server that manages information related to a print log which is a print history generated in printing in a system that prints information generated in a device as an information generation source on a medium provided with an IC tag having a unique identifier and outputs a print, comprising:
a receiver that receives the identifier of the IC tag attached to the printed medium;
a storage that receives the identifier from the receiver and stores it;
a time acquiring unit that is activated when the storage stores the identifier, notifies the storage of the time and instructs the storage to record the time as tag read time; and
a response unit that receives the identifier of the IC tag attached to the medium from an external device, acquires the tag read time corresponding to the identifier from the storage and sends the time back.

12. A print log managing method for managing a log which is a print history generated in printing in a system that prints information generated in a device as an information generation source on a medium by a printer and outputs a print, comprising the steps of:
reading information of an IC tag having a unique identifier and attached to the medium using a tag reader in printing;
acquiring information related to printing on the medium in the printer from the device as the information generation source as a log and storing the information in a log server;
receiving the identifier read by the tag reader of the IC tag, linking the time of printing on the medium or time at which the information of the IC tag is received to the identifier of the IC tag and storing the linked result in a first storage;
acquiring the time at which the identifier of the IC tag attached to the medium is received from the first storage and acquiring logs in the vicinity of the time from the log server; and
linking the acquired log and the medium and storing the linked result in a second storage.

13. A print log managing method for managing a log which is a print history generated in printing in a system that prints information generated in a device as an information generation source on a medium by a printer and outputs a print, comprising the steps of:
collecting information related to time at which print information is spooled (spooled time information) when the print information is temporarily stored in a spool device of the printer, transmitting the collected information to an ID management server, receiving identification information from the ID management server, linking the identification information to the print information and transferring the linked result to the printer;
printing the print information and the identification information on the medium;
generating unique identification information, linking the spooled time information in the printer and the identification information and managing the linked result in the ID management server;
acquiring information related to the print information on the medium in the printer from the device as the information generation source as a log and storing the information in a log server;
transmitting the identification information printed on the medium to the ID management server, acquiring the spooled time information corresponding to the identification information held in the ID management server and acquiring logs in the vicinity of the time from the log server; and
linking the acquired print log and the medium based upon the identification information and storing the linked result in a storage.
